(19) United States
(12) Patent Application Publication
(10) Pub. No.: US 2018/0101475 A1
(43) Pub. Date: Apr. 12, 2018

(54) METHOD AND DEVICE FOR COMBINING ENTRIES IN DIRECTORY

(71) Applicant: HUAWEI TECHNOLOGIES CO., LTD., Shenzhen (CN)

(72) Inventors: Lei FANG, Hangzhou (CN); Xiongli GU, Hangzhou (CN); Weiguang CAI, Hangzhou (CN)

(73) Assignee: HUAWEI TECHNOLOGIES CO., LTD., Shenzhen (CN)

(21) Appl. No.: 15/839,665

(22) Filed: Dec. 12, 2017

Related U.S. Application Data
(63) Continuation of application No. PCT/CN2015/082672, filed on Jun. 29, 2015.

(51) Int. Cl. G06F 12/0817; G06F 12/0808; G06F 12/084

(52) U.S. Cl. CPC G06F 12/0817; G06F 2212/62; G06F 12/084; G06F 12/0808

(57) ABSTRACT

Embodiments of the present disclosure disclose a method for combining entries, including: determining N to-be-combined entries, where a cache block indicated by an entry label of each entry of the N entries belongs to a combination range, and the combination range indicates 2^{a} cache blocks; and combining the N entries into a first entry, where an entry label of the first entry indicates the 2^{a} cache blocks, and a sharer number of the first entry includes a sharer number of each entry of the N entries. According to the method, entries in a directory can be combined effectively, thereby improving directory usage efficiency.

### CROSS-REFERENCE TO RELATED APPLICATIONS

This application is a continuation of International Application No. PCT/CN2015/082672, filed on Jun. 29, 2015, the disclosure of which is hereby incorporated by reference in its entirety.

### TECHNICAL FIELD

The present disclosure relates to the computer field, and in particular, to a method and a device for combining entries in a directory, and a method and a device for accessing a directory.

### BACKGROUND

In a multi-core processor, generally, each processor core has a private cache, and each private cache can be accessed only by a processor core in which the private cache is located. A shared cache is also configured on the multi-core processor, where the shared cache may be accessed by each processor core. After reading a cache block from the shared cache, each processor core may create a copy of the cache block in its private cache, and read/write the copy. Therefore, a cache block stored in the shared cache may have multiple copies created in multiple private caches. When a copy of the cache block in any one of the private caches is modified, another private cache needs to be instructed to invalidate another copy of the cache block, so as to implement coherence of a same cache block in an entire system.

A commonly used coherence protocol includes a directory-based coherence protocol, that is, an entry is used to record a storage status of a copy of each cache block in each private cache. When a private cache needs to perform an operation on a copy of a cache block, it is needed to obtain an entry corresponding to the cache block to obtain a storage status of the copy of the cache block in each private cache, so as to perform coherence processing for the copies of the cache block. However, because power consumption and area overheads of the directory cache are limited, a quantity of stored entries is limited. Generally, it is impossible to set one entry for each cache block. When entry storage of the directory cache reaches an upper limit, contention between entries is caused and an entry needs to be replaced. Each copy of a cache block recorded by the replaced entry needs to be invalidated, which causes extra communication overheads to the entire cache system. In addition, invalidation of the cache block recorded by the replaced entry causes a decrease of a cache block hit rate.

### SUMMARY

Embodiments of the present disclosure provide a method for combining entries in a directory. According to the method, directory usage efficiency can be improved effectively, and impact on a cache system due to replacement of an entry is reduced.

A first aspect of the embodiments of the present disclosure provides a method for combining entries in a directory, the directory includes multiple entries, each entry includes an entry label and a sharer number, and the entry label is used to indicate a cache block; and the method includes: determining N to-be-combined entries, where a cache block indicated by an entry label of each entry of the N entries belongs to a combination range, the combination range indicates 2^{a} cache blocks, and both N and a are positive integers; and combining the N entries into a first entry, where an entry label of the first entry indicates the 2^{a} cache blocks, and a sharer number of the first entry includes a sharer number of each entry of the N entries.

With reference to the first aspect, in a first implementation manner of the first aspect, before the combining the N entries into a first entry, the method further includes: determining whether a combination condition is met, and when the combination condition is met, combining the N entries, where the combination condition includes any one of the following conditions: the directory does not include a second entry, where an entry label of the second entry is the same as the entry label of the first entry and both indicate the 2^{a} cache blocks; or the directory includes a second entry, and an entry label of one entry of the N entries indicates labels of at least two cache blocks, where an entry label of the second entry is the same as the entry label of the first entry and both indicate the 2^{a} cache blocks; or the directory includes a second entry, an entry label of any one of the N entries indicates one cache block, and N is greater than a preset threshold, where an entry label of the second entry is the same as the entry label of the first entry and both indicate the 2^{a} cache blocks.

With reference to the first implementation manner of the first aspect, in a second implementation manner of the first aspect, after the directory includes the second entry, and the first entry is obtained by means of combination, the method further includes: deleting the second entry.

With reference to the second implementation manner of the first aspect, in a third implementation manner of the first aspect, before the deleting the second entry, the method further includes: determining whether a sharer number of the second entry is the same as the sharer number of the first entry; and if the sharer number of the second entry is different from the sharer number of the first entry, before executing the action of deleting the second entry, obtaining a redundant sharer number in the second entry, where the redundant sharer number is another sharer number that is in the second entry and that is different from the sharer number of the first entry; querying the 2^{a} cache blocks in a cache device corresponding to the redundant sharer number; determining a first cache block cached in the cache device corresponding to the redundant sharer number; and executing one of the following two actions: invalidating the first cache block cached in the cache device corresponding to the redundant sharer number, or generating a third entry, where an entry label of the third entry indicates the first cache block, and a sharer number of the third entry is the redundant sharer number.

With reference to the first implementation manner of the first aspect, in a fourth implementation manner of the first aspect, after the directory includes the second entry, and the first entry is obtained by means of combination, the method further includes: determining whether the second entry includes two or more sharer numbers; and when the second entry includes two or more sharer numbers, combining the second entry and the first entry into a fourth entry, where an entry label of the fourth entry indicates the 2^{a} cache blocks, and sharer numbers of the fourth entry include the sharer numbers of the second entry and the sharer number of the first entry.

With reference to the fourth implementation manner of the first aspect, in a fifth implementation manner of the first aspect, the method further includes: if the second entry includes only one sharer number, deleting the second entry.

With reference to the fifth implementation manner of the first aspect, in a sixth implementation manner of the first aspect, before the deleting the second entry, the method further includes: determining whether the sharer number of the second entry is the same as the sharer number of the first entry; if the sharer number of the second entry is different from the sharer number of the first entry, before the deleting the second entry, obtaining a redundant sharer number in the second entry, where the redundant sharer number is another sharer number that is in the second entry and that is different from the sharer number of the first entry; querying the 2^{a} cache blocks in a cache device corresponding to the redundant sharer number; determining a second cache block cached in the cache device corresponding to the redundant sharer number; and executing one of the following two actions: invalidating the second cache block cached in the cache device corresponding to the redundant sharer number, or generating a fifth entry, where an entry label of the fifth entry indicates the second cache block, and a sharer number of the fifth entry is the redundant sharer number.

A second aspect of the embodiments of the present disclosure provides a method for accessing a directory, where the directory includes multiple entries, each entry includes an entry label and a sharer number, the entry label is used to indicate a cache block, the multiple entries include a first entry, an entry label of the first entry indicates 2^{a} cache blocks, and a is a positive integer; and the method includes: receiving a directory access request, where the directory access request carries a label of a to-be-accessed cache block; querying the directory according to the label of the to-be-accessed cache block to obtain a group of entries corresponding to the to-be-accessed cache block, where the group of entries includes all entries in the directory whose entry labels indicate the to-be-accessed cache block; and determining a query entry from the group of entries, where the query entry is an entry, in the group of entries, whose entry label indicates fewest cache blocks.

With reference to the second aspect, in a first implementation manner of the second aspect, each entry in the directory further includes a management range flag bit, where the management range flag bit is used to indicate a quantity of cache blocks indicated by the entry label; and the determining a query entry from the group of entries includes: determining the query entry according to a management range flag bit of each entry of the group of entries.

With reference to the second aspect or the first implementation manner of the second aspect, in a second implementation manner of the second aspect, the directory access request further includes a visitor number, where the visitor number indicates a cache device sending the directory access request; and the method further includes: if a sharer number of the query entry is different from the visitor number, generating a first new entry, where an entry label of the first new entry indicates the to-be-accessed cache block, and a sharer number of the first new entry is the visitor number.

With reference to the second aspect or the second implementation manner of the second aspect, in a third implementation manner of the second aspect, the directory access request further includes a visitor number, where the visitor number indicates a cache device sending the directory access request, the directory access request further includes an access type, and the access type is used to indicate that the directory access request is a read request or a write request; and the method further includes: if the access request type indicates that the directory access request is a read request, and a sharer number of the query entry does not include the visitor number, adding the visitor number to the sharer number of the query entry.

With reference to the third implementation manner of the second aspect, in a fourth implementation manner of the second aspect, the method further includes: if the access request type indicates that the directory access request is a write request, generating a second new entry, where an entry label of the second new entry indicates the to-be-accessed cache block, and a sharer number of the second new entry is the visitor number; and instructing a cache device corresponding to another sharer number different from the visitor number in the query entry to invalidate the to-be-accessed cache block.

A third aspect of the embodiments of the present disclosure provides a device for combining entries in a directory, the directory includes multiple entries, each entry includes an entry label and a sharer number, the entry label is used to indicate a cache block, and the device includes: a determining module, configured to determine N to-be-combined entries, where a cache block indicated by an entry label of each entry of the N entries belongs to a combination range, the combination range indicates 2^{a} cache blocks, and both N and a are positive integers; and a processing module, configured to combine the N entries into a first entry, where an entry label of the first entry indicates the 2^{a} cache blocks, and a sharer number of the first entry is sharer numbers of the N entries.

With reference to the third aspect, in a first implementation manner of the third aspect, before combining the N entries into the first entry, the processing module is further configured to: determine whether a combination condition is met, and when the combination condition is met, combine the N entries, where the combination condition includes any one of the following conditions: the directory does not include a second entry, where an entry label of the second entry is the same as the entry label of the first entry and both indicate the 2^{a} cache blocks; or the directory includes a second entry, and an entry label of one entry of the N entries indicates labels of at least two cache blocks, where an entry label of the second entry is the same as the entry label of the first entry and both indicate the 2^{a} cache blocks; or the directory includes a second entry, an entry label of any one of the N entries indicates one cache block, and N is greater than a preset threshold, where an entry label of the second entry is the same as the entry label of the first entry and both indicate the 2^{a} cache blocks.

With reference to the first implementation manner of the third aspect, in a second implementation manner of the third aspect, after the directory includes the second entry, and the first entry is obtained by means of combination, the processing module is further configured to delete the second entry.

With reference to the second implementation manner of the third aspect, in a third implementation manner of the third aspect, before deleting the second entry, the processing module is further configured to: determine whether a sharer number of the second entry is the same as the sharer number of the first entry; and if the sharer number of the second entry is the same as the sharer number of the first entry, execute the action of deleting the second entry; or if the sharer number of the second entry is different from the sharer number of the first entry, before executing the action of deleting the second entry, obtain a redundant sharer number in the second entry, where the redundant sharer number is another sharer number that is in the second entry and that is different from the sharer number of the first entry; query the 2^{a} cache blocks in a cache device corresponding to the redundant sharer number; determine a first cache block cached in the cache device corresponding to the redundant sharer number; and execute one of the following two actions: invalidating the first cache block cached in the cache device corresponding to the redundant sharer number, or generating a third entry, where an entry label of the third entry indicates the first cache block, and a sharer number of the third entry is the redundant sharer number.

With reference to the first implementation manner of the third aspect, in a fourth implementation manner of the third aspect, the processing module is further configured to: after the directory includes the second entry, and the first entry is obtained by means of combination, determine whether the second entry includes two or more sharer numbers; and when the second entry includes two or more sharer numbers, combine the second entry and the first entry into a fourth entry, where an entry label of the fourth entry indicates the 2^{a} cache blocks, and sharer numbers of the fourth entry include the sharer numbers of the second entry and the sharer number of the first entry.

With reference to the fourth implementation manner of the third aspect, in a fifth implementation manner of the third aspect, the processing module is further configured to: if the second entry includes only one sharer number, delete the second entry.

With reference to the fifth implementation manner of the third aspect, in a sixth implementation manner of the third aspect, the processing module is further configured to: before deleting the second entry, determine whether the sharer number of the second entry is the same as the sharer number of the first entry; and if the sharer number of the second entry is different from the sharer number of the first entry, before deleting the second entry, obtain a redundant sharer number in the second entry, where the redundant sharer number is another sharer number that is the second entry and that is different from the sharer number of the first entry; query the 2^{a} cache blocks in a cache device corresponding to the redundant sharer number; determine a second cache block cached in the cache device corresponding to the redundant sharer number; and execute one of the following two actions: invalidating the second cache block cached in the cache device corresponding to the redundant sharer number, or generating a fifth entry, where an entry label of the fifth entry indicates the second cache block, and a sharer number of the fifth entry is the redundant sharer number.

With reference to the third aspect or the first or the second or the third or the fourth or the fifth implementation manner of the first aspect, in a sixth implementation manner of the third aspect, the device is an application-specific integrated circuit ASIC or a field programmable gate array FPGA.

A fourth aspect of the embodiments of the present disclosure provides a device for accessing a directory, where the directory includes multiple entries, each entry includes an entry label and a sharer number, the entry label is used to indicate a cache block, the multiple entries include a first entry, an entry label of the first entry indicates 2^{a} cache blocks, and a is a positive integer; and the device includes: a receiving module, configured to receive a directory access request, where the directory access request carries a label of a to-be-accessed cache block; and a processing module, configured to query the directory according to the label of the to-be-accessed cache block to obtain a group of entries corresponding to the to-be-accessed cache block, where the group of entries includes all entries in the directory whose entry labels indicate the to-be-accessed cache block; and determine a query entry from the group of entries, where the query entry is an entry, in the group of entries, whose entry label indicates fewest cache blocks.

With reference to the fourth aspect, in a first implementation manner of the fourth aspect, each entry in the directory further includes a management range flag bit, where the management range flag bit is used to indicate a quantity of cache blocks indicated by the entry label; and that the processing module determines a query entry from the group of entries includes: determining the query entry according to a management range flag bit of each entry of the group of entries.

With reference to the fourth aspect or the first implementation manner of the fourth aspect, in a second implementation manner of the fourth aspect, the directory access request further includes a visitor number, where the visitor number indicates a cache device sending the directory access request; and the processing module is further configured to: if a sharer number of the query entry is different from the visitor number, generate a first new entry, where an entry label of the first new entry indicates the to-be-accessed cache block, and a sharer number of the first new entry is the visitor number.

With reference to the fourth aspect or the first implementation manner of the fourth aspect, in a third implementation manner of the fourth aspect, the directory access request further includes a visitor number, where the visitor number indicates a cache device sending the directory access request, the directory access request further includes an access type, and the access type is used to indicate that the directory access request is a read request or a write request; and if the access request type indicates that the directory access request is a read request, and a sharer number of the query entry does not include the visitor number, the processing module adds the visitor number to the sharer number of the query entry.

With reference to the third implementation manner of the fourth aspect, in a fourth implementation manner of the fourth aspect, the processing module is further configured to: if the access request type indicates that the directory access request is a write request, generate a second new entry, where an entry label of the second new entry indicates the to-be-accessed cache block, and a sharer number of the second new entry is the visitor number; and instruct a cache device corresponding to another sharer number different from the visitor number in the query entry to invalidate the to-be-accessed cache block.

With reference to the fourth aspect or the first or the second or the third or the fourth implementation manner of the fourth aspect, in a fifth implementation manner of the fourth aspect, the device is an application-specific integrated circuit ASIC or a field programmable gate array FPGA.

A fifth aspect of the embodiments of the present disclosure provides a directory, including: a block entry, where the block entry includes a first entry label and a first sharer number; a regional entry, where the regional entry includes a second entry label and a second sharer number; and a super regional entry, where the super regional entry includes a third entry label and a third sharer number; where the first entry label indicates one cache block, the second entry label indicates 2ⁿ cache blocks, and the third entry label indicates 2^{n+m} cache blocks, where both n and m are positive integers.

With reference to the fifth aspect, in a first implementation manner of the fifth aspect, the block entry further includes a first management range flag bit, the regional entry further includes a second management range flag bit, and the super regional entry further includes a third management range flag bit; where the first management range flag bit is used to indicate a quantity of cache blocks indicated by the first entry label, the second management range flag bit is used to indicate a quantity of cache blocks indicated by the second entry label, and the third management range flag bit is used to indicate a quantity of cache blocks indicated by the third entry label.

A sixth aspect of the embodiments of the present disclosure provides a storage medium, configured to store the directory according to the first implementation manner of the fifth aspect or the fifth aspect.

A seventh aspect of the embodiments of the present disclosure provides a directory cache, including the storage medium according to the sixth aspect of the embodiments of the present disclosure, the device for combining entries in a directory according to any one of implementation manners of the second aspect or the second aspect, the device for accessing a directory according to any one of implementation manners of the fourth aspect or the fourth aspect, and a bus, where a communication connection among the storage medium, the device for combining entries in a directory, and the device for accessing a directory is set up by using the bus.

According to the provided embodiments, entries in a directory can be combined effectively, which saves directory storage space, and avoids as much as possible extra overheads generated because cache blocks managed by some entries need to be invalidated when the directory storage space reaches an upper limit.

### BRIEF DESCRIPTION OF DRAWINGS

To describe the technical solutions in the embodiments of the present disclosure or in the prior art more clearly, the following briefly describes the accompanying drawings required for the embodiments.

FIG. 1 is a diagram of a shared cache architecture of a multi-core processor applied in an embodiment of the present disclosure;

FIG. 2 is a schematic structural diagram of composition of a directory applied in Embodiment 1 of the present disclosure;

FIG. 3 is a schematic structural diagram of composition of another directory applied in Embodiment 1 of the present disclosure;

FIG. 4 is a schematic flowchart of a method for combining entries applied in method embodiment 1 of the present disclosure;

FIG. 5 is a schematic structural diagram of composition of a device for combining entries in a directory applied in device embodiment 2 of the present disclosure;

FIG. 6 is a schematic flowchart of a method for accessing a directory applied in method embodiment 2 of the present disclosure;

FIG. 7 is a schematic structural diagram of composition of a device for accessing a directory applied in device embodiment 3 of the present disclosure; and

FIG. 8 is a schematic structural diagram of composition of a directory cache device applied in device embodiment 4 of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure.

In the specification, a term “processor core” usually refers to one or more processing units of a multi-core processor chip that execute a data processing task, or may be referred to as a processor core or a processing core, or may be an integrated circuit chip having a signal processing capability, such as a general purpose processor, a digital signal processor (Digital Signal Processor, DSP), an application-specific integrated circuit (Application Specific Integrated Circuit, ASIC), or a field programmable gate array (Field Programmable Gate Array, FPGA).

In the specification, a term “directory cache” usually refers to a device having functions of storing a directory and processing an entry, in a directory based cache coherence (Directory Based Cache Coherence) system.

In the specification, a term “entry”, or referred to as a “directory entry” or “directory entry”, usually refers to an entry that is in a directory based cache coherence system and that is stored in a directory cache. Each entry records one or more entry labels, where each entry label indicates one cache block. Each entry further records one or more sharer numbers, where each sharer number indicates one processor node or one private cache.

In the specification, a term “entry label” refers to a label of a cache block. Generally, each cache block in a shared cache architecture has a unique label, and a cache block can be determined by using the label. Actually, it is assumed that a label of a cache block of a system has 4 bits, and an address of the cache block in a cache device has 12 bits. Generally, a cache line can be indexed by using the 12-bit address, and then a cache block can be found by using the 4-bit label.

In the specification, a term “sharer number” is used to indicate a cache device; a sharer number of an entry indicates a cache device corresponding to a cache block indicated by an entry label of the entry. Actually, a correspondence between a cache block recorded in the entry and a cache device is not entirely accurate, for example, there are entries 0000 to 1111-1, 2, but cache devices 1 and 2 do not necessarily store all cache blocks labeled from 0000 to 1111.

In the specification, a term “a cache block indicated by an entry label belongs to a combination range” indicates that the cache block belongs to 2^{a} contiguous cache blocks, that is, a label of the cache block belongs to labels of the 2^{a} contiguous cache blocks, where the “belong to” herein includes endpoints of two ends of the combination range. For example, a cache block A belongs to a combination range 0000 to 1111, that is, a label of the cache block A may be any one between 0000 and 1111 and including 0000 or 1111.

### Shared Cache Architecture of a Multi-Core Processor in an Embodiment

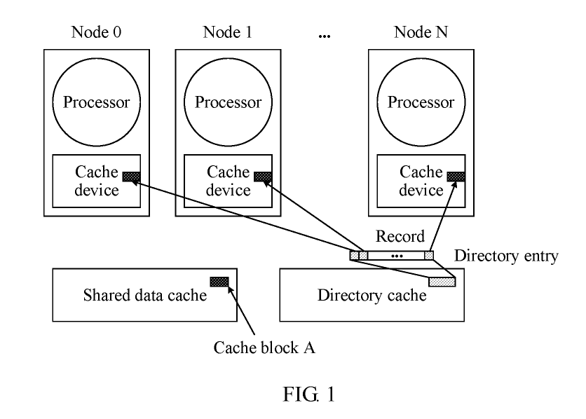

FIG. 1 is a partial schematic diagram of a shared cache architecture of a multi-core processor according to an embodiment of the present disclosure. The multi-core processor generally has multiple nodes such as a node 0 and a node 1 in FIG. 1. Each node includes a processor, or referred to as a processor core, and a cache device of each node, that is, a private cache. Only a processor of each node can access a cache device of the node, and read/write data in the cache device of the node. Data in each cache device comes from a shared data cache, where the shared data cache can be accessed by each cache device. Therefore, as shown in FIG. 1, a cache block A stored in the shared data cache may be read by the node 0, the node 1, and a node N and stored in cache devices of the node 0, the node 1, and node N, and therefore, the cache block A has three copies in the entire shared cache architecture. To ensure coherence between the copies of the cache block A in the entire architecture, for example, if the cache device of the node 0 performs a write operation on the cache block A, the node 1 and the node N need to learn that the cache blocks A stored in the cache devices of the node 1 and node N are invalid. In the shared cache architecture, a directory cache is used to ensure coherence between copies of a cache block. The directory cache records entries, where any one of the entries records labels of one or more cache blocks and sharer numbers of these cache blocks, that is, numbers of nodes on which copies of these cache blocks are located. When reading/writing a cache block in its cache device, each node needs to first access an entry recorded in the directory cache and obtain numbers of nodes on which copies of the cache block are located to ensure coherence between the copies of to-be-read/written cache block. In addition to storing an entry, the directory cache generally has a capability of processing an entry, such as finding a corresponding entry according to a directory access request, processing an entry when an entry storage capacity in the directory cache reaches an upper limit, or notifying a corresponding cache device when an entry is modified.

### Embodiment 1

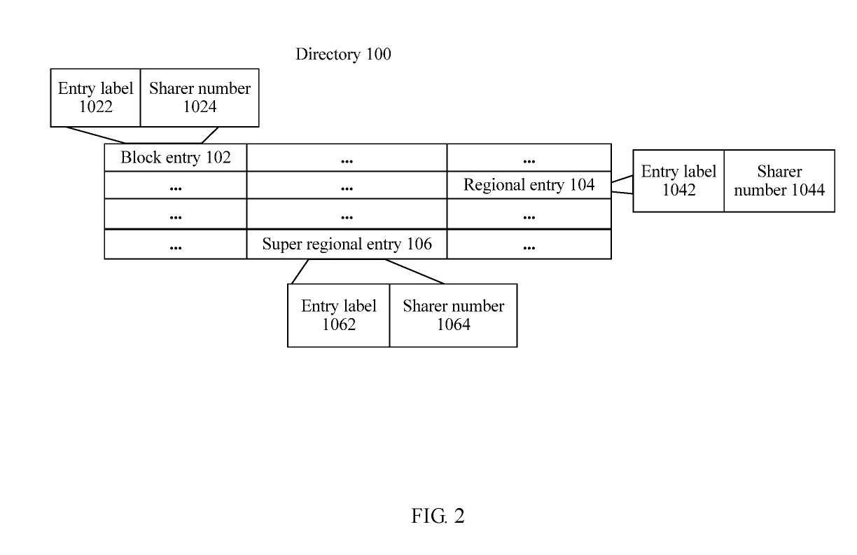

Embodiment 1 provides a directory, where the directory is applicable to the foregoing shared cache architecture. A directory 100 shown in FIG. 2 includes:

a block entry 102, including an entry label 1022 and a sharer number 1024;

a regional entry 104, including an entry label 1042 and a sharer number 1044; and

a super regional entry 106, including an entry label 1062 and a sharer number 1064.

The entry label 1022 indicates one cache block, the entry label 1042 indicates 2ⁿ cache blocks, and the entry label 1062 indicates 2^{n+m} cache blocks, where both n and m are positive integers. That is, a quantity of cache blocks managed by the super regional entry 106 may be 2^{m} times of that managed by the regional entry 104. Actually, the super regional entry 106 may include multiple super regional entries, for example, the super regional entry 106 includes a super regional entry whose entry label indicates 2ⁿ⁺¹ cache blocks, a super regional entry whose entry label indicates 2ⁿ⁺² cache blocks, and a super regional entry whose entry label indicates 2ⁿ⁺³ cache blocks. It is assumed that a super regional entry managing a largest quantity of cache blocks manages 2^{n+L} cache blocks.

Each of the sharer number 1024, the sharer number 1044, and the sharer number 1064 may include numbers of one or more cache devices; a number of each cache device indicates one node or one cache device in the architecture. Taking that the block entry 102 manages the cache block A in FIG. 1 for example, the entry label 1022 is a label of the cache block A, and the sharer number 1042 includes a number of the node 0, a number of the node 1, and a number of the node N.

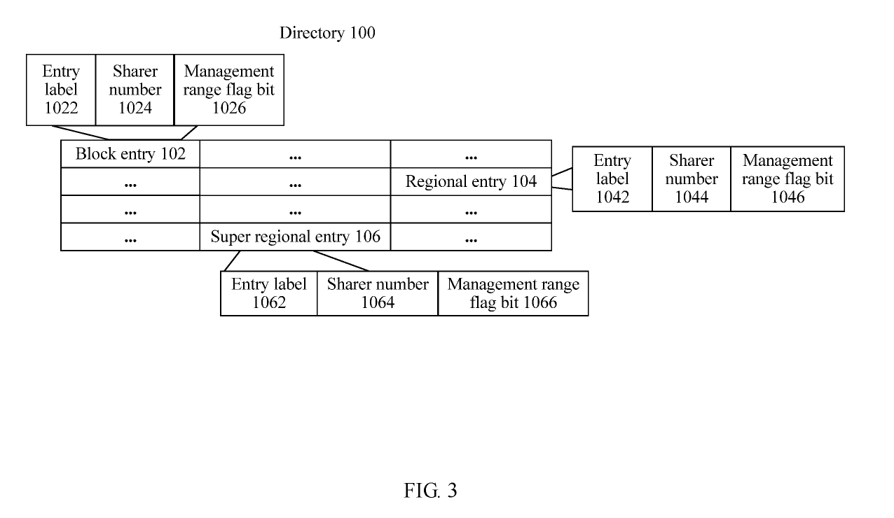

Optionally, as shown in FIG. 3, the block entry 102 further includes a management range flag bit 1026, the regional entry 104 further includes a management range flag bit 1046, and the super regional entry 106 further includes a management range flag bit 1066. The management range flag bit 1026 is used to indicate a quantity of cache blocks indicated by the entry label 1022, the management range flag bit 1046 is used to indicate a quantity of cache blocks indicated by the entry label 1042, and the management range flag bit 1066 is used to indicate a quantity of cache blocks indicated by the entry label 1062.

Actually, because labels of cache blocks managed by each entry are definitely 2ⁿ contiguous labels, an entry label of each entry may not directly indicate a cache block but indicates a start address, and then, a range of cache blocks managed by the entry is determined according to a management range flag bit. For example, if an entry label of an entry is 0011, and a management range flag bit of the entry is 0010, the management range flag bit indicates that the entry manages four cache blocks, that is, four cache blocks whose labels are 0011, 0100, 0101, and 0110. Alternatively, an entry label may indicate only high bits of a label of a cache block. For example, if an entry label is 00, and a management range flag bit is 0010, the management range flag bit indicates that the entry manages four cache blocks, where all high bits of labels of the four cache blocks are 00, and the labels of the four cache blocks are 0000, 0001, 0010, and 0011. In actual design, widths of entry label bits of all entries should be the same, and widths of management range flag bits of all entries should also be the same. In the foregoing example, when the super regional entry managing the largest quantity of cache blocks manages 2^{n+L} cache blocks, the management range flag bit needs at least log₂ (L+2)+1 bits.

A directory is provided above, where the directory provides multiple entries of different cache block management ranges. An entry with a wider management range manages more cache blocks, thereby saving directory storage space. An entry with a smaller management range increases precision of the directory. A combination use of entries with multiple management ranges improves directory usage efficiency and reduces overhead of a directory-based coherence protocol.

### Device Embodiment 1

Device embodiment 1 provides a storage medium that is used to store any directory provided in Embodiment 1, where the storage medium may be a RAM, a ROM, an EEPROM, a magnetic disk storage medium, a solid state drive, or another storage medium.

A storage medium for storing a directory is provided above, where the directory stored in the storage medium provides multiple entries of different cache block management ranges. An entry with a wider management range manages more cache blocks, thereby saving directory storage space. An entry with a smaller management range increases precision of the directory. A combination use of entries with multiple management ranges improves directory usage efficiency and reduces overhead of directory-based coherence, thereby improving working efficiency of a multi-core processor chip that uses the storage medium.

### Method Embodiment 1

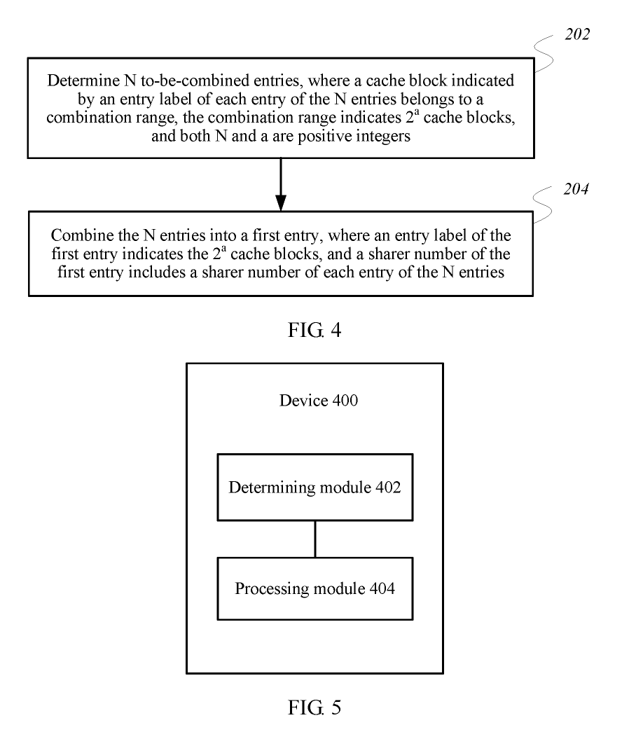

Method embodiment 1 provides a method for combining entries in a directory. Specifically, the method may be applied to a directory of any optional solution in Embodiment 1, that is, each entry in the directory includes an entry label and a sharer number, where the entry label is used to indicate a cache block. FIG. 4 is a schematic flowchart of the method, where the method includes:

Step 202: Determine N to-be-combined entries, where a cache block indicated by an entry label of each entry of the N entries belongs to a combination range, the combination range indicates 2^{a} cache blocks, and both N and a are positive integers.

Step 204: Combine the N entries into a first entry, where an entry label of the first entry indicates the 2^{a} cache blocks, and a sharer number of the first entry includes a sharer number of each entry of the N entries.

If the cache block indicated by the entry label of each entry of the N entries belongs to the combination range, and sharer numbers of the N entries are the same, the sharer number of the first entry combined in step 204 is the sharer numbers of the N entries.

For example, if a directory includes four entries, an entry label of each entry indicates one or more cache blocks, and all labels of all cache blocks indicated by the four entries are within a range of 0000 to 0011, therefore 0000 to 1111 is a current combination range, and a is equal to 2. If labels of cache blocks that are respectively managed by the four entries are 0000, 0001, 0010, and 0011, and sharer numbers of the four entries are the same, for example, the sharer numbers of the four entries are 1, which indicates a cache device whose number is 1, the four entries are combined into a first entry. An entry label of the first entry is 0000 to 0011, and a sharer number of the first entry indicates the cache device 1. 0000-1 in the following indicates that an entry label of an entry is 0000, which indicates a cache block of a label 0000, and a sharer number indicates a cache device 1; 0000 to 1111-1, 2 indicates that an entry label of an entry indicates 16 cache blocks labeled from 0000 to 1111, and a sharer number indicates a cache device 1 and a cache device 2. A meaning of an entry in the specification may be deduced from this.

It should be noted that, a minimum value of a is a management range of a regional entry in the directory. If the regional entry in the directory is set to manage labels of eight cache blocks, the minimum value of a may be 3 herein, and the first entry is a regional entry; or a may be set to an integer greater than 3, and in this case, the first entry is a super regional entry. In addition, the sharer number of the entry may further indicate two or more cache devices. For example, if a is 4 and the four entries are respectively 0000-1, 2, 0001-1, 2, 0010-1, 2, and 1000 to 1111-1, 2, the four entries are combined into a first entry, and the first entry is 0000 to 1111-1, 2.

If the cache block indicated by the entry label of each entry of the N entries belongs to the combination range, and not all sharer numbers of the N entries are the same, the sharer number of the first entry combined in step 204 includes the sharer numbers of every entry of the N entries.

For example, if a directory includes four entries, an entry label of each entry indicates one or more cache blocks, a value of a is 2, and all labels of all cache blocks indicated by the four entries are within a range of 0000 to 0011, the four entries are 0000-1, 0001-2, 0010-1, and 0011-3 and are combined into 0000 to 0011-1, 2, 3.

It should be noted that, a minimum value of a is a management range of a regional entry in the directory. If the regional entry in the directory is set to manage labels of eight cache blocks, the minimum value of a may be 3 herein, and the first entry is a regional entry; or a may be set to an integer greater than 3, and in this case, the first entry is a super regional entry. For example, if a is 4 and the four entries are respectively 0000-1, 2, 0001-1, 3, 0010-1, and 1000 to 1111-2, 4, the four entries are combined into the first entry, and the first entry is 0000 to 1111-1, 2, 3, 4.

It should be further noted that, usually step 202 is initiated when entry storage space of the directory reaches an upper limit. When a new entry needs to be generated, step 202 and step 204 are performed to combine entries in the directory to save storage space occupied by the entries and leave storage space for the new entry, which avoids a system load caused by a case in which the existing entry needs to be deleted when the new entry needs to be generated. Step 202 may be initiated when entry storage space of the directory does not reach an upper limit, that is, combination of the entries in the directory may be initiated regularly or initiated according to another preset rule.

Optionally, if each entry in the directory further includes a management range flag bit, when the N entries are combined into the first entry, a management range flag bit of the first entry needs to be further generated, where the management range flag bit is used to indicate that the entry label of the first entry indicates the 2^{a} cache blocks. For example, if a is 4, and four entries are respectively 0000-1-1, 2, 0001-1-1, 2, 0010-1-1, 2, and 1000-8-1, 2, where 0000-1-1, 2 indicates that an entry label of the entry is 0000, a management range flag bit is 1, and therefore the entry manages only a cache block of a label 0000, and a sharer number indicates a cache device 1 and a cache device 2; and 1000-8-1, 2 indicates a management range flag bit of the entry is 8, and therefore the entry manages eight cache blocks of labels 1000 to 1111, and a sharer number indicates the cache device 1 and the cache device 2. A meaning of an entry with a management range flag bit in the specification may be deduced from this. A first entry combined from the four entries 0000-1, 2, 0001-1, 2, 0010-1, 2, and 1000 to 1111-1, 2 may be 0000-16-1, 2.

Optionally, before step 204 of combining the N entries into a first entry, the method further includes: determining whether a combination condition is met, and when the combination condition is met, combining the N entries, where the combination condition includes any one of the following conditions: the directory does not include a second entry, where an entry label of the second entry indicates the foregoing 2^{a} contiguous cache blocks, and the N entries are combined into the first entry; or the directory includes a second entry, and an entry label of one entry of the N entries indicates labels of at least two cache blocks; or the directory includes a second entry, an entry label of any one of the N entries indicates one cache block, and N is greater than a preset threshold.

Specifically, if there is the second entry in the directory whose entry label is the same as that of the first entry, it needs to be determined whether to replace the second entry with the first entry. As described in the foregoing example, 0000-1, 2, 0001-1, 2, 0010-1, 2, and 1000 to 1111-1, 2 are combined into 0000 to 1111-1, 2. If there is a second entry in the directory whose entry label is 0000 to 1111, the first entry conflicts with the second entry, and two entries with a same entry label cannot exist in the directory. In this case, it needs to be determined whether to replace the second entry with the first entry. In either of the following two cases, the first entry is obtained by means of combination: in case 1, if one entry of the N entries is a regional entry or a super regional entry, that is, an entry label of one entry of the N entries indicates labels of at least two cache blocks, the first entry is used to replace the second entry; and in case 2, if any one of the N entries is a block entry, and N is greater than a preset threshold, the first entry is used to replace the second entry. If the foregoing two cases are not met, the second entry is retained, the N entries are not combined into the first entry, and combination at this time is cancelled. Generally, if there is a regional entry or a super regional entry in to-be-combined entries, or there is a large quantity of block entries in to-be-combined entries, combination at this time greatly improves efficiency of the directory, and therefore, under this condition, the first entry is used to replace the second entry.

Optionally, after step 204 of obtaining the first entry by means of combination, the method further includes: deleting the second entry. As described in the foregoing, if there is a second entry conflicting with the first entry, and it is determined that the first entry is obtained by means of combination, the second entry needs to be deleted to avoid a case that two entries with the same entry label are in the directory.

Optionally, in step 204, before the deleting the second entry, the method further includes: determining that a sharer number of the second entry is different from the sharer number of the first entry; before executing the action of deleting the second entry, obtaining a redundant sharer number in the second entry, where the redundant sharer number is another sharer number that is in the second entry and that is different from the sharer number of the first entry; querying the 2^{a} cache blocks in a cache device corresponding to the redundant sharer number; determining a first cache block cached in the cache device corresponding to the redundant sharer number; and invalidating the first cache block cached in the cache device corresponding to the redundant sharer number, or generating a third entry, where an entry label of the third entry indicates the first cache block, and a sharer number of the third entry is the redundant sharer number.

Specifically, as described in the foregoing example, for example, 0000-1, 2, 0001-1, 2, 0010-1, 2, and 1000 to 1111-1, 2 are combined into 0000 to 1111-1, 2. If there is a second entry 0000 to 1111-1, 2, 3 in the directory, after 0000 to 1111-1, 2 is determined, the second entry needs to be deleted. Before the second entry is deleted, a redundant sharer number further needs to be obtained. In this case, the redundant sharer number is a number of a cache device 3. A first cache block is obtained, where a label of the first cache block indicates a cache block whose label is in an interval from 0000 to 1111 and that is stored in the cache device 3. If the label of the first cache block is 0011, a third entry 0011-3 is generated, that is, a new block entry is used to maintain the first cache block. After the redundant sharer number is obtained, except for generating the new entry to manage the first cache block, and a cache block whose label is in the interval from 0000 to 1111 and that is stored in the cache device corresponding to the redundant sharer number should be invalidated. The second entry needs to be deleted, and therefore, if there is a sharer number in the second entry beyond a protection scope of the sharer number of the first entry, a new block entry needs to be generated to protect a cache block in the interval from 0000 to 1111 and that is in the unprotected sharer number in the second entry, or the cache block needs to be invalidated because there may be no entry, in the directory, that can manage the cache block.

Optionally, after step 204 of obtaining the first entry by means of combination, the method further includes: determining whether the second entry includes two or more sharer numbers; and when the second entry includes two or more sharer numbers, combining the second entry and the first entry into a fourth entry, where an entry label of the fourth entry indicates the 2^{a} cache blocks, and sharer numbers of the fourth entry include the sharer numbers of the second entry and the sharer number of the first entry.

As described in the foregoing example, for example, 0000-1, 2, 0001-1, 3, 0010-1, and 1000 to 1111-2, 4 are combined into 0000 to 1111-1, 2, 3, 4. If there is no entry in the directory whose entry label is 0000 to 1111, there is no second entry, and the entry 0000 to 1111-1, 2, 3, 4 is directly obtained by means of combination and stored in the directory. If there is a second entry in the directory whose entry label is 0000 to 1111-2, 3, 4, 5, and the second entry includes two or more sharer numbers, the first entry and the second entry are combined into a fourth entry, where the fourth entry is 0000 to 1111-1, 2, 3, 4, 5.

Optionally, after step 204 of obtaining the first entry by means of combination, and after the directory includes the second entry, and the first entry is obtained by means of combination, if the second entry includes only one sharer number, the second entry is deleted.

As described in the foregoing example, if there is a second entry in the directory whose entry label is 0000 to 1111-3, that is, the second entry includes only one sharer number, the second entry is deleted.

Optionally, in step 204, before the deleting the second entry, the method further includes: determining that a sharer number of the second entry is different from the sharer number of the first entry; before executing the action of deleting the second entry, obtaining a redundant sharer number in the second entry, where the redundant sharer number is another sharer number that is in the second entry and that is different from the sharer number of the first entry; querying the 2^{a} cache blocks in a cache device corresponding to the redundant sharer number; determining a first cache block cached in the cache device corresponding to the redundant sharer number; and invalidating the first cache block cached in the cache device corresponding to the redundant sharer number, or generating a third entry, where an entry label of the third entry indicates the first cache block, and a sharer number of the third entry is the redundant sharer number.

Specifically, as described in the foregoing example, for example, 0000-1, 2, 0001-1, 2, 0010-1, 2, and 1000 to 1111-1, 2 are combined into 0000 to 1111-1, 2. If there is a second entry 0000 to 1111-1, 2, 3 in the directory, after 0000 to 1111-1, 2 is determined, the second entry needs to be deleted. Before the second entry is deleted, a redundant sharer number further needs to be obtained. In this case, the redundant sharer number is a number of a cache device 3. A first cache block is obtained, where a label of the first cache block indicates a cache block whose label is in an interval from 0000 to 1111 and that is stored in the cache device 3. If the label of the first cache block is 0011, a third entry 0011-3 is generated, that is, a new block entry is used to maintain the first cache block. After the redundant sharer number is obtained, except for generating the new entry to manage the first cache block, and a cache block whose label is in the interval from 0000 to 1111 and that is stored in the cache device corresponding to the redundant sharer number should be invalidated. The second entry needs to be deleted, and therefore, if there is a sharer number in the second entry beyond a protection scope of the sharer number of the first entry, a new block entry needs to be generated to protect a cache block in the interval from 0000 to 1111 and that is in the unprotected sharer number in the second entry, or the cache block needs to be invalidated because there may be no entry, in the directory, that can manage the cache block.

The foregoing provides a method for combining entries in a directory. According to the method, entries in the directory whose cache block labels are in a specific range can be combined effectively, which saves directory storage space, and avoids as much as possible extra overheads generated because cache blocks managed by some entries need to be invalidated when the directory storage space reaches an upper limit. In addition, impact on directory usage efficiency after directory combination is appropriately considered in the combination method.

### Device Embodiment 2

Device embodiment 2 provides a device 400 for combining entries in a cache coherence directory. The device 400 is specifically configured to combine entries in a directory of any optional solution in Embodiment 1. A schematic structural diagram of composition of the device 400 is shown in FIG. 5, where the device 400 includes:

a determining module 402, configured to determine N to-be-combined entries, where a cache block indicated by an entry label of each entry of the N entries belongs to a combination range, the combination range indicates 2^{a} cache blocks, and both N and a are positive integers; and

a processing module 404, configured to combine the N entries into a first entry, where an entry label of the first entry indicates the 2^{a} cache blocks, and a sharer number of the first entry is sharer numbers of the N entries.

The determining module 402 specifically performs step 202 in method embodiment 1 and all optional solutions of step 202.

The processing module 404 specifically performs step 204 in method Embodiment 1, and all optional solutions of step 204.

A communication connection is set up between the determining module 402 and the processing module 404; and both the determining module 402 and the processing module 404 set up a communication connection to a storage medium, in device embodiment 1, that is used to store a directory provided in Embodiment 1.

For example, a working scenario of the device 400 is as follows: When entry storage space of the directory stored in the storage medium of device embodiment 1 reaches an upper limit, and a new entry needs to be generated, the determining module 402 first accesses the directory stored in the storage medium to determine N entries meeting the foregoing conditions in the directory, and the processing module 404 combines the N entries in the directory into the first entry. Work of the device 400 may also be initiated when the entry storage space of the directory does not reach the upper limit, that is, combination of entries in the directory may be initiated regularly or initiated according to another preset rule.

Optionally, the device 400 may be an ASIC or an FPGA. Generally, to match a high-speed operating frequency of a cache device, an operation on the directory is also implemented by a hardware device.

The foregoing provides a device for combining entries in a directory. The device can effectively combine entries in the directory whose cache block labels are in a specific range, which saves directory storage space, and avoids as much as possible extra overheads generated because cache blocks managed by some entries need to be invalidated when the directory storage space reaches an upper limit. In addition, impact on directory usage efficiency after directory combination is appropriately considered in the combination method.

### Method Embodiment 2

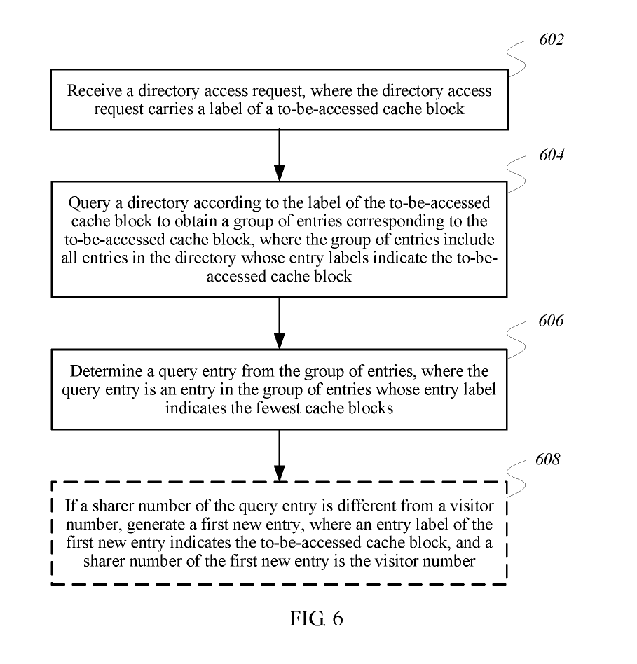

Method embodiment 2 provides a method for accessing a directory of any optional solution in Embodiment 1, where the directory includes multiple entries, each entry includes an entry label and a sharer number, the entry label is used to indicate a cache block, the multiple entries include a first entry, an entry label of the first entry indicates 2^{a} cache blocks, and a is a positive integer. A schematic flowchart of the method is shown in FIG. 6, including:

Step 602: Receive a directory access request, where the directory access request carries a label of a to-be-accessed cache block.

Step 604: Query the directory according to the label of the to-be-accessed cache block to obtain a group of entries corresponding to the to-be-accessed cache block, where the group of entries includes all entries in the directory whose entry labels indicate the to-be-accessed cache block.

Step 606: Determine a query entry from the group of entries, where the query entry is an entry, in the group of entries, whose entry label indicates fewest cache blocks.

For example, the label of the to-be-accessed cache block, carried in the directory access request, is 0011, and the directory is queried according to the label to obtain all entries whose entry labels indicate the cache block of the label 0011, for example, an entry whose entry label range is 0000 to 0011 and an entry whose entry label range is 0000 to 1000, where these entries form a group of entries. After the group of entries is obtained, a query entry is determined from the group of entries.

Optionally, each entry of the directory further includes a management range flag bit, where the management range flag bit is used to indicate a quantity of cache blocks indicated by the entry label. In step 1006, the determining a query entry from the group of entries includes: determining the query entry according to a management range flag bit of each entry in the group of entries.

For example, the label of the to-be-accessed cache block, carried in the directory access request, is 0011, and the obtained group of entries includes an entry whose entry label range is 0011, an entry whose entry label range is 0000 to 0011, an entry whose entry label range is 0000 to 1000, and the like. According to a management range flag bit of each entry, an entry whose entry label indicates fewest cache blocks is determined from the group of entries. For example, in the foregoing example, a management range flag bit of the entry whose entry label range is 0011 indicates that the entry manages only one cache block, a management range flag bit of the entry whose entry label range is 0000 to 0011 indicates that the entry manages four cache blocks, and a management range flag bit of the entry whose entry label range is 0000 to 1000 indicates that the entry manages 16 cache blocks; therefore, the entry whose entry label range is 0011 is the query entry.

Optionally, in step 1002, the received directory access request further includes a visitor number, that is, a number of a node sending the directory access request, or a number of a cache device of the node. After step 602, the method further includes step 608: If a sharer number of the query entry is different from the visitor number, generate a first new entry, where an entry label of the first new entry indicates the to-be-accessed cache block, and a sharer number of the first new entry is the visitor number. For example, if the query entry is 0011-1-3, and the visitor number is 2, 0011-1-2 is generated to manage an operation on a cache block 0011 by a cache device 2. If the sharer number of the query entry is the same as the visitor number, an operation on the cache block 0011 is directly performed according to the first entry.

Optionally, the directory access request includes the foregoing visitor number, and further includes an access type, where the access type is used to indicate that the directory access request is a read request or a write request. Step 1008 further includes: if the access request type indicates that the directory access request is a read request, and a sharer number of the query entry does not include the visitor number, adding the visitor number to the query entry. For example, if the query entry is 0011-1-3, 4, the visitor number is 2, and the directory access request is a read request, the query entry is modified to 0011-1-2, 3, 4. Because the directory access request is a read request, the cache block 0011 is not modified, and another copy of the cache block 0011 does not need to be invalidated. If the sharer number of the query entry includes the visitor number, the directory does not need to be modified according to the directory access request, and an operation is directly performed on the cache block 0011 according to the first entry.

Optionally, if the access request type indicates that the directory access request is a write request, step 608 further includes: generating a second new entry, where an entry label of the second new entry indicates the to-be-accessed cache block, and a sharer number of the second new entry is the visitor number; and instructing a cache device corresponding to a sharer number different from the visitor number in the query entry to invalidate the to-be-accessed cache block. If the directory access request is a write request, a block entry needs to be generated to individually manage a copy that is of the cache block 0011 and that is in a cache device corresponding to the visitor number. For example, if the visitor number is 2, and the first entry is 0011-1-2, 3, 4, a second new entry 0011-1-2 is generated, and the cache block 0011 in cache devices 3 and 4 is invalidated, so as to implement coherence of the cache block 0011 in an entire cache system.

The foregoing provides a method for accessing a directory. According to the method, entries of multiple granularities and different management ranges can be accessed, an entry with a minimum management range is selected as an access object, and a corresponding operation is performed according to an actual access type and content of an accessed entry, to access the directory flexibly and efficiently and improve directory usage efficiency.

### Device Embodiment 3

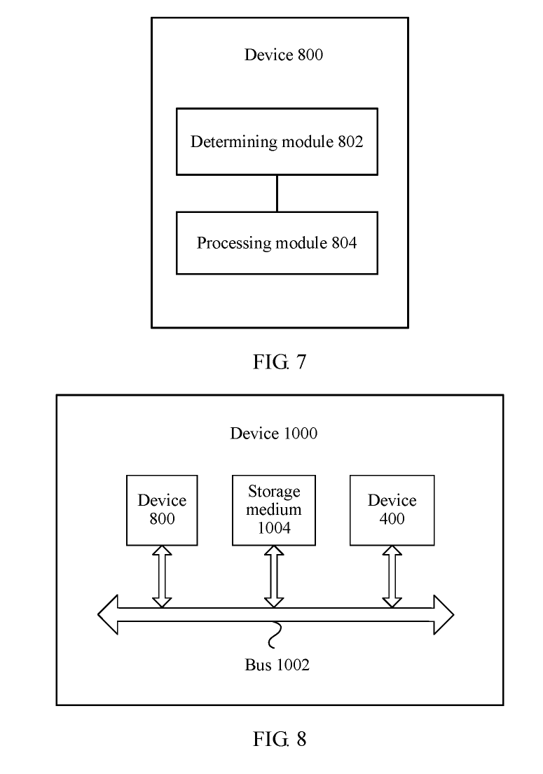

Device embodiment 3 provides a device 800 for accessing a directory, where the directory includes multiple entries, each entry includes an entry label and a sharer number, the entry label is used to indicate a cache block, the multiple entries include a first entry, an entry label of the first entry indicates 2^{a} cache blocks, and a is a positive integer. A schematic structural diagram of composition of the device 800 is shown in FIG. 7, including:

a receiving module 802, configured to receive a directory access request, where the directory access request carries a label of a to-be-accessed cache block; and

a processing module 804, configured to query the directory according to the label of the to-be-accessed cache block to obtain a group of entries corresponding to the to-be-accessed cache block, where the group of entries includes all entries in the directory whose entry labels indicate the to-be-accessed cache block; and determine a query entry from the group of entries, where the query entry is an entry, in the group of entries, whose entry label indicates fewest cache blocks.

The receiving module 802 specifically performs step 602 in method embodiment 2 and all optional solutions of step 602.

The processing module 804 specifically performs step 604, step 606, and step 608 in method embodiment 2, and all optional solutions of step 604, step 606, and step 608.

A communication connection is set up between the receiving module 802 and the processing module 804; and both the receiving module 802 and the processing module 804 set up a communication connection to a storage medium, in device embodiment 1, that is used to store a directory provided in Embodiment 1.

For example, a working scenario of the device 800 is as follows: When a cache block of a cache device needs to be accessed, a directory access request is sent first to the receiving module 802 of the device 800; after obtaining the directory access request from the receiving module 802, the processing module 804 obtains the query entry, and can implement an access operation on the cache block according to content recorded in the query entry.

Optionally, the device 800 may be an ASIC or an FPGA. Generally, to match a high-speed operating frequency of a cache device, access to the directory is also implemented by a hardware device.

The foregoing provides a device for accessing a directory. According to the device, entries of multiple granularities and different management ranges can be accessed, an entry with a minimum management range is selected as an access object, and a corresponding operation is performed according to an actual access type and content of an accessed entry, to access the directory flexibly and efficiently and improve directory usage efficiency.

### Device Embodiment 4

Device embodiment 4 provides a directory cache device 1000, including any optional device 400 in device embodiment 2, any optional device 800 in device embodiment 3, and a storage medium 1004 in device embodiment 1. A communication connection is set up among the device 400, the device 800, and the storage medium 1004 by using a bus 1002. A schematic structural diagram of composition of the directory cache device is shown in FIG. 8.

For example, a working scenario of the device 1000 is as follows: When a cache block of a cache device needs to be accessed, the device 800 is responsible for accessing, according to a received directory access request, the storage medium 1004 storing a directory, to obtain a corresponding entry. If a new entry needs to be added to the directory in an access process, but existing entry storage space in the storage medium 1004 has reached an upper limit, the device 400 combines entries in the directory to save directory storage space and leave storage space for the new entry.

The foregoing provides a directory cache device. According to the device, entries of multiple granularities and different management ranges can be accessed, an entry with a minimum management range is selected as an access object, and a corresponding operation is performed according to an actual access type and content of an accessed entry, to access a directory flexibly and efficiently. In addition, entries in the directory can be further combined to improve storage efficiency of the directory, avoid a loss brought by deletion of the entry in the directory to a cache system, and improve directory usage efficiency.

In the foregoing embodiments, the description of each embodiment has respective focuses. For a part that is not described in detail in an embodiment, reference may be made to related descriptions in other embodiments. It should be noted that, the device in device embodiment 2 is a device executing the method in method embodiment 1, and therefore reference may be made between them; the device in device embodiment 3 is a device executing the method in method embodiment 2, and therefore reference may be made between them.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. A method for processing a directory, wherein the directory comprises multiple entries, each entry comprises an entry label and at least one sharer number, the entry label indicates at least one cache block, and each sharer number indicates a cache device for storing the at least one cache block; and the method comprises:
determining N entries from the multiple entries in the directory, wherein a cache block indicated by an entry label of each entry of the N entries belongs to a combination range, the combination range indicates 2^{a} contiguous cache blocks, and both N and a are positive integers; and
combining the N entries into a first newly combined entry, wherein an entry label of the first newly combined entry indicates the 2^{a} contiguous cache blocks, and the first newly combined entry comprises all sharer number of every entry of the N entries.

2. The method according to claim 1, before combining the N entries into the first newly combined entry, the method comprises:
determining the N entries met a combination condition, wherein the combination condition comprises any one of the following conditions:
the directory does not comprise an existing entry which comprises an entry label indicating the 2^{a} contiguous cache blocks;
the directory comprises an existing entry which comprises an entry label indicating the 2^{a} contiguous cache blocks, and an entry label of at least one entry of the N entries indicates at least two cache blocks;
the directory comprises an existing entry which comprises an entry label indicating the 2^{a} contiguous cache blocks, an entry label of any one of the N entries indicates one cache block, and N is greater than a preset threshold.

3. The method according to claim 2, the method further comprises:
determining whether the existing entry comprises one sharer number or two or more sharer numbers;
if the existing entry comprises one sharer number, deleting the existing entry;
if the existing entry comprises two or more sharer numbers, combining the first newly combined entry and the existing entry into a second newly combined entry, wherein an entry label of the second newly combined entry indicates the 2^{a} contiguous cache blocks, and the second newly combined entry comprises every sharer number of both the first newly combined and the existing entry.

4. The method according to claim 3, before deleting the existing entry, the method further comprises:
if the sharer number of the existing entry is not comprised in the first newly combined entry, executing one of the following two actions:
invalidating the 2^{a} contiguous cache blocks stored in a cache device indicated by the sharer number of the existing entry; generating a first new entry, wherein an entry label of the first new entry indicates the 2^{a} contiguous cache blocks, and the first new entry comprises the sharer number of the existing entry.

5. The method according to claim 2, if the directory comprises the existing entry, the method further comprises:
determining a redundant sharer number in the existing entry, wherein the redundant sharer number is not comprised in the first newly combined entry;
executing one of the following two actions: invalidating the 2^{a} contiguous cache blocks stored in a cache device indicated by the redundant sharer number; generating a second new entry, wherein an entry label of the second new entry indicates the 2^{a} contiguous cache blocks, and the second new entry comprises the redundant sharer number; and
deleting the existing entry.

6. A method for accessing a directory, wherein the directory comprises multiple entries, each entry comprises an entry label and at least one sharer number, the entry label indicates at least one cache block, and each sharer number indicates a cache device for storing the at least one cache block; and the method comprises:
receiving a directory access request, wherein the directory access request carries a label of a to-be-accessed cache block;
querying the directory according to the label of the to-be-accessed cache block to obtain at least one fitting entry, wherein an entry label of each fitting entry indicates the to-be-accessed cache block; and
determining a target entry from the at least one fitting entry, wherein the target entry is an entry, in the at least one fitting entry, whose entry label indicates fewest cache blocks.

7. The method according to claim 6, wherein said each entry in the directory further comprises a management range flag bit, wherein the management range flag bit is used to indicate a quantity of cache blocks indicated by said each entry label; and
the determining the target entry from the at least one fitting entry comprises:
determining the target entry according to a management range flag bit of each entry in the at least one fitting entry.

8. The method according to claim 6, wherein the directory access request further comprises a visitor number, wherein the visitor number indicates a cache device sending the directory access request, the directory access request further comprises an access type, and the access type is used to indicate that the directory access request is a read request or a write request; and the method further comprises:
if the access request type indicates that the directory access request is a read request and the target entry does not comprise the visitor number, adding the visitor number to the target entry.

9. The method according to claim 6, wherein the directory access request further comprises a visitor number, wherein the visitor number indicates a cache device sending the directory access request, the directory access request further comprises an access type, and the access type is used to indicate that the directory access request is a read request or a write request; and the method further comprises:
if the access request type indicates that the directory access request is a write request, generating a third new entry, wherein an entry label of the third new entry indicates the to-be-accessed cache block and the third new entry comprises the visitor number; and
instructing a redundant cache device corresponding to a redundant sharer number to invalidate the to-be-accessed cache block storing in the redundant cache device, wherein the redundant sharer number is comprised in the target entry and different from the visitor number.

10. A device for processing a directory, wherein the directory comprises multiple entries, each entry comprises an entry label and at least one sharer number, the entry label indicates at least one cache block, and each sharer number indicates a cache device for storing the at least one cache block; and the device comprises:
a determining module, configured to determine N entries from the multiple entries in the directory, wherein a cache block indicated by an entry label of each entry of the N entries belongs to a combination range, the combination range indicates 2^{a} contiguous cache blocks, and both N and a are positive integers; and
a processing module, configured to combine the N entries into a first newly combined entry, wherein an entry label of the first newly combined entry indicates the 2^{a} contiguous cache blocks, and the first newly combined entry comprises all sharer number of every entry of the N entries.

11. The device according to claim 10, the processing module is further configured to:
before combining the N entries into the first newly combined entry, determine the N entries met a combination condition, wherein the combination condition comprises any one of the following conditions:
the directory does not comprise an existing entry which comprises an entry label indicating the 2^{a} contiguous cache blocks;
the directory comprises an existing entry which comprises an entry label indicating the 2^{a} contiguous cache blocks, and an entry label of at least one entry of the N entries indicates at least two cache blocks;
the directory comprises an existing entry which comprises an entry label indicating the 2^{a} contiguous cache blocks, an entry label of any one of the N entries indicates one cache block, and N is greater than a preset threshold.

12. The device according to claim 11, the processing module is further configured to:
determine whether the existing entry comprises one sharer number or two or more sharer numbers;
if the existing entry comprises one sharer number, delete the existing entry;
if the existing entry comprises two or more sharer numbers, combine the first newly combined entry and the existing entry into a second newly combined entry, wherein an entry label of the second newly combined entry indicates the 2^{a} contiguous cache blocks, and the second newly combined entry comprises every sharer number of both the first newly combined and the existing entry.

13. The device according to claim 12, the processing module is further configured to:
before deleting the existing entry, if the sharer number of the existing entry is not comprised in the first newly combined entry, execute one of the following two actions: invalidate the 2^{a} contiguous cache blocks stored in a cache device indicated by the sharer number of the existing entry; generate a first new entry, wherein an entry label of the first new entry indicates the 2^{a} contiguous cache blocks, the first new entry comprises the sharer number of the existing entry.

14. The device according to claim 11, the processing module is further configured to:
if the directory comprises the existing entry, determine a redundant sharer number in the existing entry, wherein the redundant sharer number is not comprised in the first newly combined entry;
execute one of the following two actions: invalidate the 2^{a} contiguous cache blocks stored in a cache device indicated by the redundant sharer number; generate a second new entry, wherein an entry label of the second new entry indicates the 2^{a} contiguous cache blocks, and the second new entry comprises the redundant sharer number; and
delete the existing entry.

15. A device for accessing a directory, wherein the directory comprises multiple entries, each entry comprises an entry label and at least one sharer number, the entry label indicates at least one cache block, and each sharer number indicates a cache device for storing the at least one cache block; and the device comprises:
a receiving module, configured to receive a directory access request, wherein the directory access request carries a label of a to-be-accessed cache block;
a processing module, configured to query the directory according to the label of the to-be-accessed cache block to obtain at least one fitting entry, wherein an entry label of each fitting entry indicates the to-be-accessed cache block; and determine a target entry from the at least one fitting entry, wherein the target entry is an entry, in the at least one fitting entry, whose entry label indicates fewest cache blocks.

16. The device according to claim 15, wherein said each entry in the directory further comprises a management range flag bit, wherein the management range flag bit is used to indicate a quantity of cache blocks indicated by said each entry label; and
the processing module is configured to, determine the target entry according to a management range flag bit of each entry in the at least one fitting entry.

17. The device according to claim 15, wherein the directory access request further comprises a visitor number, wherein the visitor number indicates a cache device sending the directory access request, the directory access request further comprises an access type, and the access type is used to indicate that the directory access request is a read request or a write request; and
the processing module is further configured to, if the access request type indicates that the directory access request is a read request and the target entry does not comprise the visitor number, add the visitor number to the target entry.

18. The device according to claim 15, wherein the directory access request further comprises a visitor number, wherein the visitor number indicates a cache device sending the directory access request, the directory access request further comprises an access type, and the access type is used to indicate that the directory access request is a read request or a write request; and
the processing module is further configured to, if the access request type indicates that the directory access request is a write request, generate a third new entry, wherein an entry label of the third new entry indicates the to-be-accessed cache block and the third new entry comprises the visitor number; and
instruct a redundant cache device corresponding to a redundant sharer number to invalidate the to-be-accessed cache block storing in the redundant cache device, wherein the redundant sharer number is comprised in the target entry and different from the visitor number.
